(19) United States
(12) Patent Application Publication
(10) Pub. No.: US 2009/0228663 A1
(43) Pub. Date: Sep. 10, 2009

(54) CONTROL CIRCUIT, CONTROL METHOD, AND CONTROL PROGRAM FOR SHARED MEMORY

(75) Inventor: Kiyohisa ICHINO, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/394,424

(22) Filed: Feb. 27, 2009

(30) Foreign Application Priority Data
Mar. 7, 2008 (JP) 2008-058815
Jun. 4, 2008 (JP) 2008-147503

(51) Int. Cl. G06F 12/10

(52) U.S. Cl. 711/148; 711/E12.066

(57) ABSTRACT

A shared memory control method parallel processes ordered access requests (AccReq) for a shared memory received from processors or threads. The method includes dividing the shared memory into memory areas, receiving the ordered AccReq for each memory area, executing the AccReq when a described order number (OrdNum) described in the AccReq matches an OrdNum expected for access, increasing or decreasing the expected OrdNum expected by the memory area to be accessed by a predetermined number when the type of the AccReq is “READ ONLY” or “WRITE” or “NO OPERATION”, saving the AccReq into a queue independently assigned to each memory area when the described OrdNum in the AccReq does not match the expected OrdNum, and sequentially fetching the AccReq from the queue and executing the AccReq as long as a described OrdNum described in the AccReq preserved in the queue matches an expected OrdNum corresponding to the queue.

This application is based upon and claims the benefit of priority from Japanese patent application No. 2008-058815, filed on Mar. 7, 2008 and Japanese patent application No. 2008-147503, filed on Jun. 4, 2008, the disclosure of which is incorporated herein in its entirety by reference.

### BACKGROUND OF THE INVENTION

1. Field of the Invention

The present invention relates to a control circuit, control method, and control program for a shared memory, and more particularly, to a control circuit, control method, and control program for a shared memory, suitable for parallelly executing processing in which the order (sequence) depends on an environment in which a plurality of processors exist.

2. Description of the Related Art

Microprocessors have been dramatically improved in clock frequency and performance in step with the evolution of semiconductor technologies. In recent years, however, miniaturization of semiconductor processes is getting near to the limit, and an increase in clock frequency of microprocessor is also slowing down.

In such a circumstance, instead of increasing clock frequency, semiconductor manufacturers have exerted efforts for improvements in processing speed of microprocessor by mounting a plurality of processor cores (CPUs, hereinafter simply referred to as the “core” as well) on a single microprocessor die of a microprocessor, such that the plurality of cores are configured to share processing of the microprocessor. For example, a multi-core processor which contains two-four cores on a single die has been previously available on the market for use in general-purpose personal computers, and research and development has been diligently under way for a many-core processor which is mounted with several tens or more of cores.

Transitions from a single-core processor to a multi-core processor, and further to a many-core processor are reshaping programming approaches as well. In order to maximally exploit the performance of a multi-core processor or a many-core processor, a programming approach suitable for parallel processing by a plurality of processor is required, as is widely appreciated. In this regard, a “processor” as used in this specification refers to a logical processor. Specifically, when a plurality of cores exists in a single physical processor, each of the cores is referred to as a “processor.”

Here, known parallelization approaches for causing a plurality of processors to execute parallel processing may be classified into a time-division parallelization approach and a space-division parallelization approach.

First, in time-division parallelization, as shown in FIG. 1, each processor 80-1, 80-2, 80-3 is dedicated to single processing allocated thereto, i.e., step A which involves processing for accessing resource a; step B which involves processing for accessing resource b; or step C which involves processing for accessing resource c, such that the processing is executed in parallel, in just the same way as a flow system which utilizes belt conveyers in a product assembling factory. For this reason, time-division parallelization is also referred to as a “pipe line system.” Here, resources a, b, c are, for example, memories, I/O or the like.

On the other hand, in space-division parallelization, as shown in FIG. 2, inputs are distributed one by one to processors 90-1, 90-2, 90-3, at a stage previous to processors 90-1, 90-2, 90-3, such that each processor 90-1, 90-2, 90-3 executes all processing for a single input, i.e., step A which involves processing for accessing resource a; step B which involves processing for accessing resource b; or step C which involves processing for accessing resource c.

Whether time-division parallelization or space-division parallelization is preferred for a parallelization approach for cause a plurality of processors to execute parallel processing, is a problem which is determined depending on the nature of the processing which is subjected to parallelism. In communication processing, time-division parallelization is often used.

This is because of order dependency of communication processing.

Specifically, in information communication, a communication message is contained in a receptacle called a packet (or a frame) before it is transmitted. Since an upper limit is set to the length of this packet, a long message exceeding the upper limit is divided into a plurality of packets for transmission. The main reasons for setting the upper limit to the length of the packet are to prevent a situation in which a single packet occupies a communication line for a long time, and because there is a limited amount of memory in a communication device.

Assume, by way of example, that a communication message is “HELLO,” and the upper limit to the packet length is three characters. Assume also that contents of received packets are recorded in a memory to reconstruct the message. In this case, the transmitter transmits two packets corresponding to “HEL” and “LO,” respectively, in order. If the receiver processes these two packets in reverse order, “LOHEL” will be recorded in a memory of the receiver, and the message cannot be correctly restored. In other words, in a communication transmission, it is impossible or inappropriate to process packets in a different order.

On the other hand, in the time-division parallelization, since all inputs are processed in the order in which they are input, a reversal of the processing order cannot essentially take place. For this reason, when the receiver employs the time-division parallelization, as two packets arrive at the receiver in the order of “HEL” and “LO,” the contents of the packets are recorded in the order of “HEL” and “LO” without fail in the memory of the receiver, so that the correct message “HELLO” is restored.

In the space-division parallelization, in turn, after inputs have been distributed to each processor 90-1, 90-2, 90-3, the processing order of the inputs is not guaranteed unless an exclusive control is conducted that recognizes the order among processors 90-1, 90-2, 90-3 when resources a, b, c are used. Specifically, when the receiver employs the space-division parallelization, if the two packets arrive at the receiver sequentially in the order of “HEL” and “LO,” the processing of “LO” can precede the processing of “HEL.” If this situation occurs, the message is inconveniently recorded in the memory of the receiver in the order of “LO” and “HEL.” To prevent such an event, a high-level access exclusive control that recognizes the order is required to suspend recording of “LO” if the contents of the packets are to be recorded in the memory of the receiver in the order of “LO” and “HEL,” and preferentially records “HEL” first.

In order to avoid confusion when using shared resources, a semaphore-based exclusive control has been conventionally known. However, the semaphore is intended to solve a competing condition in which a plurality of processors (threads in a broader sense) simultaneously claim the right of use for a small number of resources. When an order is defined in the use of resources, the semaphore does not have the ability to provide a processor with the right to use the resources in that order. Accordingly, the shared resource exclusive control that recognizes the order, which is required in the space-division parallelization, cannot be implemented by the semaphore. In this way, since the space-division parallelization implies a problem in shared resource exclusive control, time-division parallelization is often employed for processing which exhibits the order dependence, such as communication processing.

Next, time-division parallelization and space-division parallelization are compared to discuss merits and demerits thereof from the viewpoint of power consumption. Generally, when certain processing is divided into a plurality of steps (for example, step A, step B, step C) for execution, the respective steps are not independent of one another, and the processing advances in such a manner that an intermediate result calculated by the preceding step is taken over by the next step. Accordingly, time-division parallelization involves a hand-over of data D1, D2 between a processor and the next processor, as shown in FIG. 1.

As the number of processors increases, the total amount of handed-over data, flowing between processors, increases, resulting in an increase in power consumed by inter-processor communications. For this reason, in the development of many-core processors, an excessive increase in power consumed by data communications between processors is a problem.

From a view point of power saving, space-division parallelization is advantageous over time-division parallelization. The reason for this is, as is apparent from FIG. 2, that in space-division parallelization, processing for a certain input (for example, step A, step B, step C) is executed in a single processor, so that the communication amount between processors is smaller than that in time-division parallelization.

Summarizing the foregoing, the following conclusion can be made that time-division parallelization is more suitable than space-division parallelization for processing which exhibits the order dependency, such as communication processing, unless power consumption is not taken into consideration. This is because, as described above, time-division parallelization can always guarantee the order, whereas space-division parallelization requires a shared resource exclusive control that recognizes the order, and this cannot be accomplished by conventional semaphore. On the other hand, the data communication amount between processors in space-division parallelization is smaller than that in time-division parallelization. As described above, since the data communication amount is closely related to power consumption, space-division parallelization is advantageous over time-division parallelization in regard to power consumption.

JP-2000-090059-A, JP-2001-222466-A, JP-2002-229848-A, and JP-11-338833-A describe multi-processor systems.

As described above, when processing which exhibits an order dependency, like communication processing in an environment in which a plurality of processors exist, is executed in parallel, space-division parallelization cannot be employed before because of the absence of means for implementing shared resource exclusive control that recognizes the order, giving rise to an inconvenient problem in which time-division parallelization cannot but be utilized though it is disadvantageous as regards power efficiency.

### SUMMARY OF THE INVENTION

The present invention has been made in view of the circumstance described above, and it is an object of the invention to provide a control circuit, control method, and control program for a shared memory, which are capable of reducing the data communication amount between processors, achieving lower power consumption, and conducting shared resource exclusive control that recognizes of the order even in parallel communication processing in an environment in which a plurality of processors exist.

A shared memory control method for parallelly processing ordered access requests for a shared memory, received from a plurality of processors or threads, according to an exemplary aspect of the invention, includes:

dividing the shared memory into a plurality of memory areas;

receiving the ordered access request from the processor or thread for each of the memory areas;

executing the access request when a described order number described in the access request matches an expected order number expected by the memory area to be accessed;

increasing or decreasing the expected order number expected by the memory area to be accessed by a predetermined number when the type of the access request is “READ ONLY” or “WRITE” or “NO OPERATION”;

saving the access request into a queue independently assigned to each of the memory areas when the described order number described in the access request does not match the expected order number expected by the memory area to be accessed; and

sequentially fetching the access request from the queue and executing the access request as long as a described order number described in the access request preserved in the queue matches an expected order number expected by the memory area corresponding to the queue.

A shared memory control circuit for parallelly processing ordered access requests for a plurality of memory areas which partition shared memory, the access requests being received from a plurality of processors or threads, according to an exemplary aspect of the invention, includes:

a memory area information memory for storing an expected order number expected by the memory area, and a queue identifier for the memory area for each of the memory areas;

a set of queues capable of preserving the access request received from the processor or thread in each memory area to be accessed; and

an access arbitration unit configured to:

read the expected order number expected by the memory area to be accessed, and the queue identifier of the memory area to be accessed from the memory area information memory each time an access request is received from the processor or thread, and execute the access request when a described order number described in the access request matches the order number expected by the memory area to be accessed;

increase or decrease the expected order number expected by the memory area to be accessed by a predetermined number when the type of the access request is “READ ONLY” or “WRITE” or “NO OPERATION”;

save the access request into a queue independently assigned to each of the memory areas when the described order number described in the access request does not match the expected order number expected by the memory area to be accessed; and

sequentially fetch the access request from the queue and execute the access request as long as a described order number described in the access request that is preserved in the queue matches an expected order number expected by the memory area corresponding to the queue.

The above and other objects, features, and advantages of the present invention will become apparent from the following description with reference to the accompanying drawings which illustrate an example of the present invention.

### BRIEF DESCRIPTION OF THE DRAWINGS

FIG. 1 is an explanatory diagram of time-division parallelization;

FIG. 2 is an explanatory diagram of space-division parallelization;

FIG. 3 is a block diagram showing an exemplary configuration for implementing a shared memory control method according to the present invention;

FIG. 4 is an explanatory diagram showing an exemplary internal structure of shared memory 2;

FIG. 5 is an explanatory diagram showing an exemplary internal structure of block property memory 3;

FIG. 6 is an explanatory diagram showing an exemplary internal structure of queue memory 4;

FIG. 7 is an explanatory diagram showing exemplary operations of flow identification unit 10;

FIG. 8 is an explanatory diagram showing exemplary formats for request 53 and replay 54;

FIG. 9 is a flow chart showing exemplary operations of access arbitration unit 5;

FIG. 10 is a flow chart showing exemplary operations of access arbitration unit 5;

FIG. 11 is a flow chart showing exemplary operations of access arbitration unit 5;

FIG. 12 is an explanatory diagram showing a specific example of request 53 input to access arbitration unit 5 and reply 54 output by access arbitration unit 5;

FIG. 13 is an explanatory diagram showing the contents of shared memory 2, block property memory 3, and queue memory 4 in a time series order when access arbitration unit 5 processes request 53 in FIG. 12.

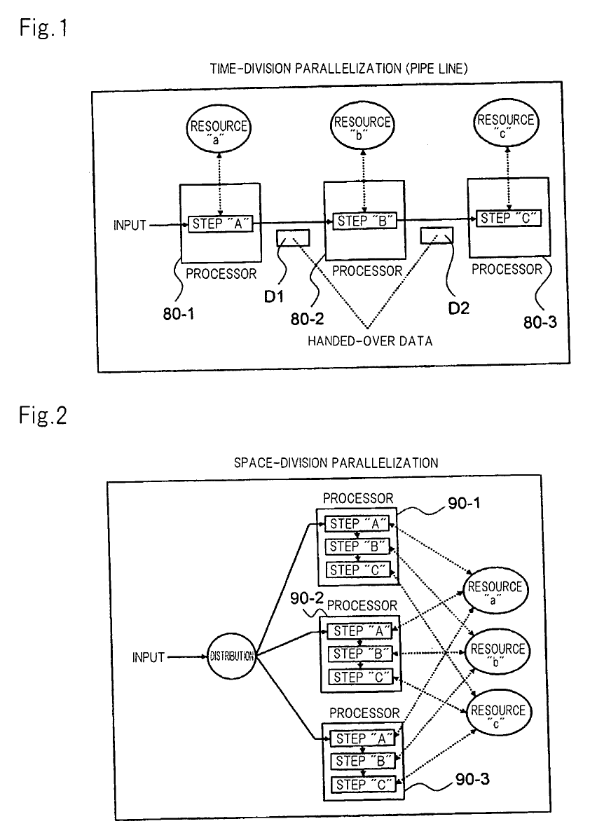

### DETAILED DESCRIPTION OF EXEMPLARY EMBODIMENT(S)

Exemplary embodiments of the present invention increase or decrease an expected order number, which is expected by a memory area to be accessed, by a predetermined number when the type of an access request is “read only,” “write,” or “no operation.” Preferably, the expected order number may be increased by “1,” but the present invention is not so limited.

The exemplary embodiments of the present invention can be implemented, for example, by causing a computer to execute each processing in a shared memory control method, as shown below, with the aid of software. Specifically, the present invention can be implemented by a control program which causes a computer to function as an access arbitration unit shown below.

Also, each processing in the shared memory control method, as shown below, may be executed by a computer which reads and executes the control program recorded on a computer readable recording medium.

### Embodiment 1

In the following, an exemplary embodiment of the present invention will be described in detail with reference to the drawings.

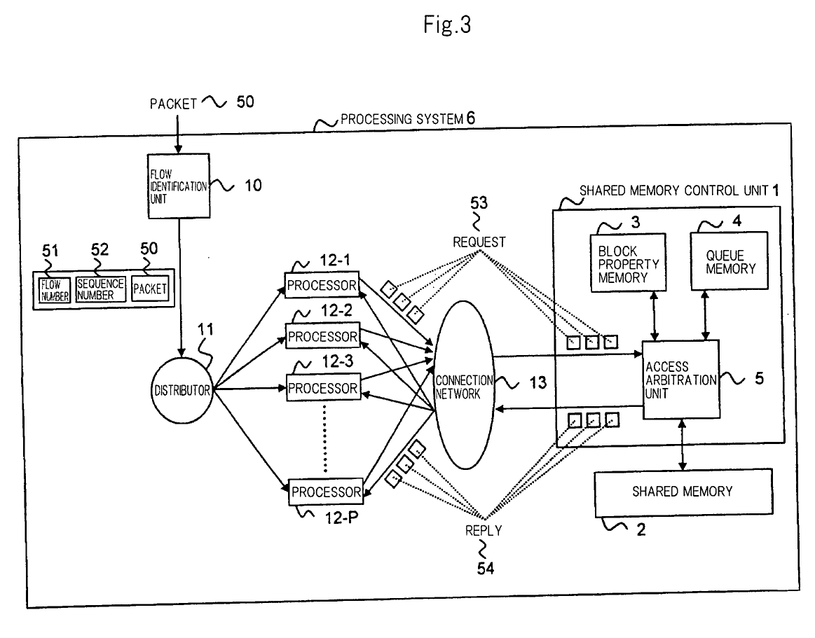

FIG. 3 is a block diagram showing the electric configuration of processing system 6 which incorporates shared memory control unit 1 which is a first exemplary embodiment of the present invention.

Processing system 6 in this embodiment is associated with a communication data processing system for parallelly executing communication data processing which exhibits an order dependency in an environment in which a plurality of processors exist. As shown in FIG. 3, processing system 6 generally comprises shared memory control unit 1, shared memory 2, flow identification unit 10, distributor 11, P (P is a natural number equal to or more than two) processors 12 (12-1, 12-2, . . . , 12-P), and connection network 13. Each of these components will be described one by one.

As shown in FIG. 3, shared memory control unit 1 is connected to P processors 12 through connection network 13. Shared memory control unit 1 receives requests 53 for memory access from each processor 12 (12-1, 12-2, . . . , 12-P), accesses shared memory 2, and returns replies 54 to processors 12 as required. The type of connection network 13 may be a known one, for example, bus, ring, mesh, cross-bar, or the like.

Processor 12 presents to shared memory control unit 1 sequence number 62 indicative of the order at which request 53 should be processed, when it issues request 53 representative of an access request to shared memory 2. Shared memory control unit 1 processes access requests in order from request 53 which has the smallest sequence number 62.

Sequence number 62 is determined by flow identification unit 10. Flow identification unit 10 identifies flows of input packets 50, and gives flow number 51, which is a unique number, to each flow, as shown in FIG. 3. The flow refers to a group of packets which are semantically linked to one another. Flow number 51 is assumed to be a non-negative integer for the purpose of facilitating the description of this embodiment. Further, flow identification unit 10 counts the cumulative total of input packets 50 on a flow-by-flow basis. As shown in FIG. 3, flow identification unit 10 designates this cumulative total value as sequence number 52, appends sequence number 52 to packet 50 together with flow number 51, and sends packet 50 to distributor 11. In this regard, the identification of a flow and counting of the number of packets are both quite general techniques in the communication field.

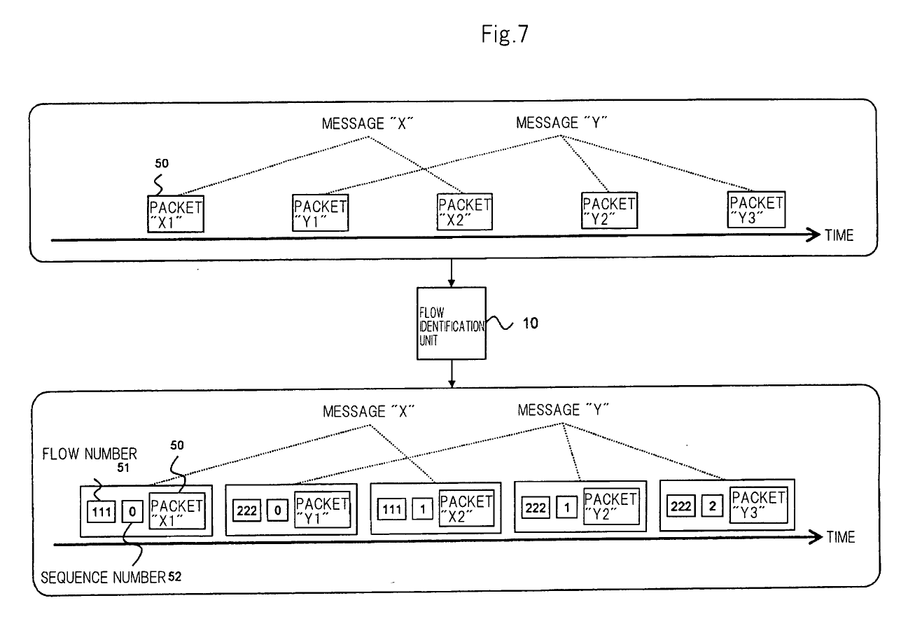

FIG. 7 is a diagram showing a specific example of the operation of flow identification unit 10. FIG. 7 shows how two packets x1, x2, which make up message X, and three packets y1, y2, y3, which make up message Y, are input to flow identification unit 10 in the order of x1→y1→x2→y2→y3, and how each packet 50 is assigned flow number 51 and sequence number 52 and is output.

In the example of FIG. 7, flow number 51 assigned to message X is “111,” while flow number 51 assigned to message Y is “222.” Also, sequence numbers 52 given to packets x1, x2, belonging to message X, are 0, 1 in this order, while sequence numbers 52 given to packets y1, y2, y3, belonging to message Y, are 0, 1, 2 in this order.

As described above, a flow is a group of packets which will be semantically related to one another, so that two flows of message X and message Y exist in this example. In messages, an order-based dependence relationship lies between packets belonging to the same flow, but no dependence relationship generally exist between different flows.

In other words, message X and message Y are correctly restored if the following three conditions are all satisfied in this example.

Condition 1: packet x1 is processed at a timing before packet x2 is processed.

Condition 2: packet y1 is processed at a timing before packet y2 is processed.

Condition 3: packet y2 is processed at a timing before packet y3 is processed.

For example, even if processing system 6 processes packets 50 in an order different from the input order such as y1→x1→y2→x2→y3, inconvenience will not occur because the foregoing conditions are satisfied. Stated another way, processing system 6 can change the order in which packets 50 are processed as long as the foregoing conditions are satisfied. Taking advantage of this nature, it is possible to increase the degree of parallelism for the processing, and improve the performance of processing system 6.

Distributor 11 distributes packets 50 input from flow identification unit 10 to processors 12 (12-1, 12-2, . . . , 12-P) together with flow number 51 and sequence number 52. Widely known algorithms for selecting a destination include, for example, a round robin scheme which is easy to implement, a load diffusion method which measures loads on processors 12 and selects the lowest loaded processor 12 as a destination, and the like.

Each processor 12 processes packets 50 allocated thereto. In the course of this processing, each processor 12 may issue request 53 for accessing shared memory 2. An area of shared memory 2 accessible by each processor 12 is limited to an area corresponding to flow number 51 which is added to packet 50 currently processed by processor 12 itself. A correspondence relationship of flow number 51 to an accessible area will be later described.

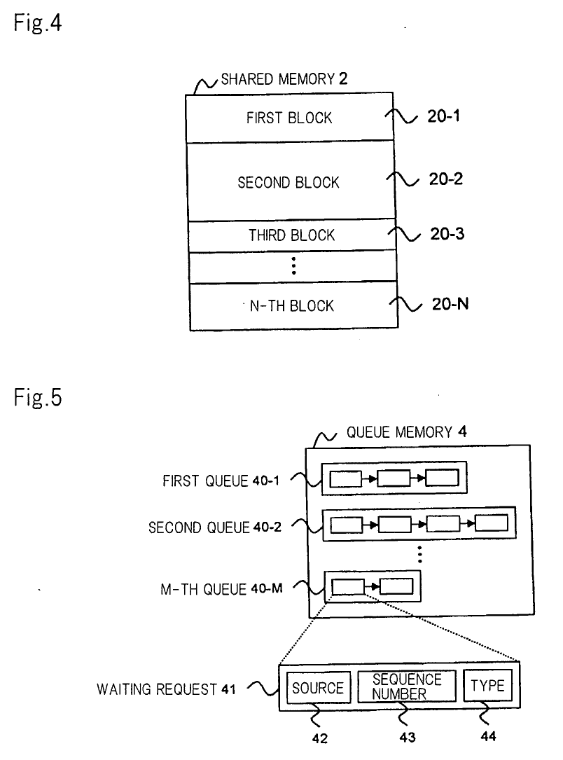

As shown in FIG. 4, shared memory 2 is a memory for storing data related to the flows of packets 50 input to processing system 6, and as shown in FIG. 4, the area of shared memory 2 is divided into N (N≧2) blocks 20 (20-1, 20-2, . . . , 20-N), such that these blocks 20 store information related to the flows. Here, information on a certain flow may distributively exist within a plurality of blocks 20. Processor 12 which is processing packet 50 can access one or more blocks 20 which contain information on a flow corresponding to flow number 51 of packet 50.

Here, a description will be given of the type and format of request 53.

Accesses to shared memory 2 are all represented in the form of request 53. Four types of requests 53, “READ,” “READ_ONLY,” “WRITE,” and “NOP” (No Operation) are received by shared memory control unit 1.

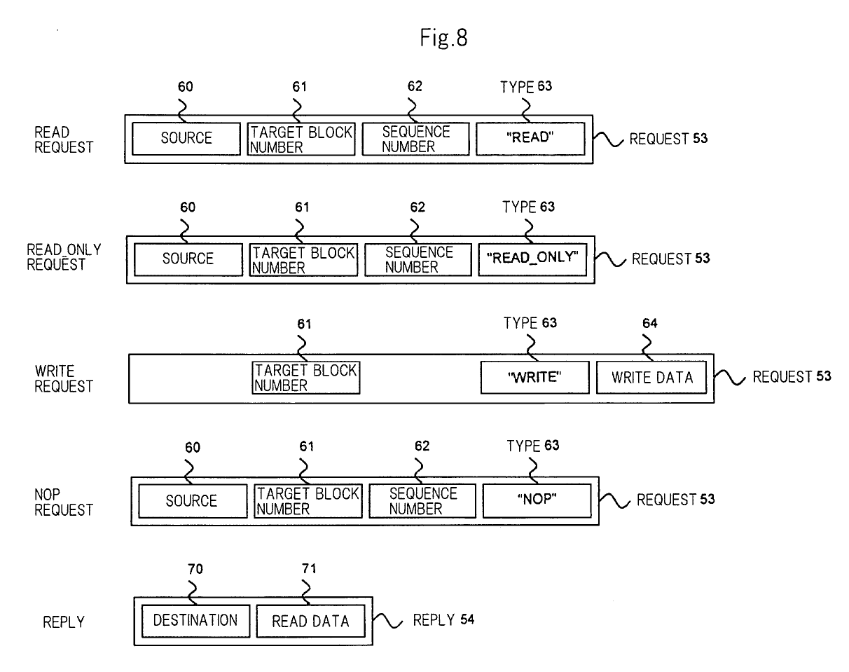

FIG. 8 shows formats for respective requests 53 “READ,” “READ_ONLY,” “WRITE,” and “NOP,” and reply 54.

Each of requests 53 “READ,” “READ_ONLY,” and “NOP” is comprised of source 60, target block number 61, sequence number 62, and type 63, as shown in FIG. 8. Request 53 “WRITE” is comprised of target block number 61, type 63, and write data 64, as shown in FIG. 8.

When target block number 61 of request 53 has a value equal to X (0≦X<N), request 53 can access [(20-(X+1)]th block 20-(X+1) within blocks 20 of shared memory 2. Therefore, when information on a flow corresponding to flow number 51 of packet 50 is contained in block 20-(X+1), processor 12 which is processing that packet 50 sets its target block number 61 to X, when it issues request 53. When the information on the flow corresponding to flow number 51 is stored in a plurality of blocks 20, each processor 12 independently issues requests 53 to respective blocks 20.

Type 63 of request 53 takes the value of either “READ” or “READ_ONLY” or “WRITE” or “NOP.” It should be noted that in this embodiment, type 63 is represented by a character string, which is a formal way for improving readability. Actually, it should be understood that type 63 can be more efficiently represented by a numerical value or a flag bit.

Source 60 indicates any one of processors 12 (12-1, 12-2, . . . , 12-P) which has issued pertinent request 53. However, in this embodiment, when a plurality of threads are operating on processor 12, source 60 is configured to additionally have information for identifying a thread which has issued request 53.

Sequence number 62 determines the order at which request 53 is processed by shared memory control unit 1. However, the order of processing is only established between requests 53 which have the same target block number 61. Shared memory control unit 1 considers that no order dependency exists among two or more requests 53 which have target block numbers 61 different from one another, and does not control the processing order among requests 63 which have different target block numbers 61. Each processor 12, upon issuing request 53, substitutes sequence number 52 (FIG. 7) of packet 50, which is being processed by processor 12 itself, into sequence number 62 (FIG. 8) of request 53.

Next, referring to FIG. 8, a description will be given of operations performed by shared memory control unit 1 (access arbitration unit 5) when it receives each of requests 53 “READ,” “READ_ONLY,” “WRITE,” and “NOP.”

First, operations associated with READ request 53 will be described.

Upon receipt of READ request 53 from arbitrary processor 12, shared memory control unit 1 reads data stored in block 20 corresponding to target block number 61 of shared memory 2, places the read data into read data 71 within reply 54, and returns reply 54 to source 60 which has issued READ request 53.

Here, READ request 53 is a read request which will involve a write operation in the future, and is configured to be always associated with WRITE request 53. Specifically, upon receipt of reply 54 to READ request 53, source 60 must create the contents of updated block 20, place them into write data 64 within WRITE request 53, and then issue this WRITE request 53 to write data back into block 20 of shared memory 2. When source 60 does not rewrite the contents of block 20, source 60 must substitute the contents of read data 71 within reply 54 into write data 64 within WRITE request 53, and then issue this WRITE request 53.

READ request 53 and WRITE request 53, which form a pair, must have the same target block number 61. In this regard, when the contents of block 20 is simply referenced without any intent to update block 20 from the beginning, it is recommended to use READ_ONLY request 53, next described, instead of READ request 53.

Next, a description will be given of operations associated with READ_ONLY request 53.

Upon receipt of READ_ONLY request 53 from arbitrary processor 12, shared memory control unit 1 reads data stored in block 20 corresponding to target block number 61 of shared memory 2, places the read data into read data 71 within reply 54, and returns reply 54 to source 60 which has transmitted READ_ONLY request 53. Here, READ_ONLY request 53 differs from READ request 53 only in that with READ_ONLY request 53, source 60 cannot issue WRITE request 53 in response to reply 54.

As described above, WRITE request 53 is always used in combination with READ request 53. NOP request 53, in turn, is provided to notify shared memory control unit 1 that no operation will be performed on block 20 corresponding to target block number 61 of shared memory 2.

Next, a description will be given of why NOP request 53 is necessary.

As described above, shared memory control unit 1 attempts to orderly process requests 53 beginning with the request that has smallest sequence number 62. Therefore, if processor 12 does not issue request 53, sequence number 62 will “skip” so that requests 53 which have sequence number 62 larger than this lost sequence number 62 and which access the same block 20 will not be processed endlessly. As a result, processing system 6 falls into a stack state. To prevent such an inconvenient situation, in this embodiment, even if each processor 12 decides not to access block 20 with “READ” request, “READ_ONLY” request, “WRITE” request or the like in the course of processing packet 50, processor 12 substitutes sequence number 52 of this packet 50 into sequence number 62 of NOP request 53, and issues this NOP request 53. With such a strategy, the continuity of sequence numbers 62 can be maintained in shared memory control unit 1.

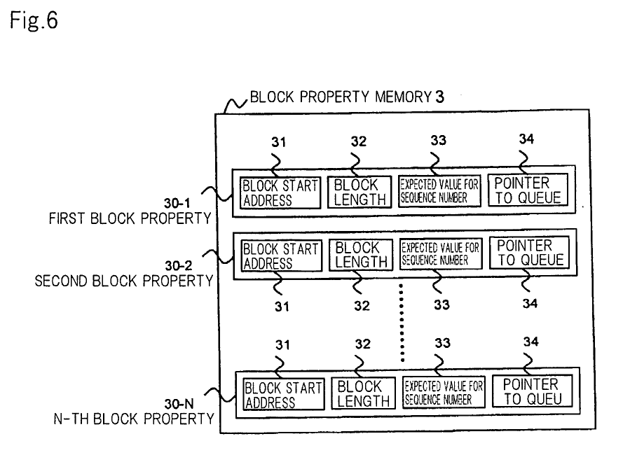

Shared memory control unit 1 comprises block property memory 3, queue memory 4, and access arbitration unit 5, as shown in FIG. 3. FIG. 5 is a conceptual diagram showing the internal configuration of block property memory 3, and FIG. 6 is a conceptual diagram showing the internal configuration of queue memory 4.

Queue memory 4 is a memory for holding requests 53, the executions of which are suspended. Shared memory control unit 1 temporarily saves request 53 in queue memory 4 without immediately executing the same, when it receives request 53 which simultaneously satisfies the following two conditions. Specifically, shared memory control unit 1 temporarily saves request 53 in queue memory 4 without immediately executing the same, when it receives request 53, whose type 63 is a type other than “WRITE” as Condition 1, and when received request 53 has sequence number 62 different from expected value 33 for a sequence number of block property 30 corresponding to target block number 61 thereof, as Condition 2.

Queue memory 4 is comprised of M queues 40 at a maximum, where each queue 40 (40-1, 40-2, . . . , 40-M) is configured such that requests 53 having the same target block number 61 are linked together while they are waiting therein. Here, quantity M of queue 40 is set to a value equal to the maximum number of requests 53 which can be issued simultaneously by P processors 12. For example, when three threads are operating respectively on processor 12, and each thread is likely to issue request 53, the value of M is set to M=3×P.

Actually, in order to save the memory, elements of queues 40 are not complete requests 53 but are subsets of requests 53. This subset is referred to as “waiting request 41.” Waiting request 41 is comprised of source 42, sequence number 43, and type 44, and they correspond to source 60, sequence number 62, and type 63 of original request 53, respectively.

In queue 40, waiting requests 41 are arranged in sequence such that their sequence number 43 are in an ascending order.

Next, block property memory 3 holds the state of each block 20 (20-1, 20-2, . . . , 20-N) of shared memory 2 in an array form of N block properties 30 (30-1, 30-2, . . . , 30-N). Block property 30-x (1≦x≦N) corresponds to block 20-X. Each block property 30 is a structure comprised of four elements (block start address 31, block length 32, expected value 33 for the sequence number, and pointer 34 to the queue).

Block start address 31 and block length 32 of block property 30-X (1≦X≦N) contain the start address and the size of block 20-X in shared memory 2, respectively. In this regard, when the start address and size of block 20-X can be determined from the value of X (1≦X≦N), block start address 31 and block length 32 of block property 30-X may be omitted in order to save memory. When they can be omitted, for example, N blocks (20-1, 20-2, . . . , 20-N) are all equal in size within shared memory 2 and are arranged at equal intervals, in which case block start address 31 and block length 32 can be omitted.

Expected value (expected order number) 33 for the sequence number of block property 30-X (1≦X≦N) is sequence number 62 of request 53 which is permitted to access block 20-X. Stated another way, this means that only when sequence number 62 of request 53, the target block number of which is X (0≦X≦N), matches expected value 33 for the sequence number of block property 30-(X+1), access arbitration unit 5 (FIG. 3) of shared memory control unit 1 is permitted to execute this request 53.

Each time the execution of request 53 other than READ is completed in each block property 30, “1” is added to expected value 33 for the sequence number of block property 30 corresponding to target block number 61 thereof. For facilitating the description, the initial value for expected value 33 for the sequence number is zero.

Pointer 34 to the queue of block property 30-X (1≦x≦N) stores an address (queue identifier) in queue memory 4 of queue 40 which holds request 53 which is suspended to access block 20-X. When there exists no request 53, the execution of which is suspended, pointer 34 to the queue indicates NULL (invalid value). The initial value for pointer 34 to the queue is NULL.

In shared memory control unit 1, access arbitration unit 5 (FIG. 3) processes received request 53, and executes an exclusive access to shared memory 2 while recognizing the sequence according to sequence number 62 in accordance with a predetermined algorithm. In this event, access arbitration unit 5 accesses block property memory 3 and queue memory 4. Also, access arbitration unit 5 generates and returns reply 54 to source 60 as required.

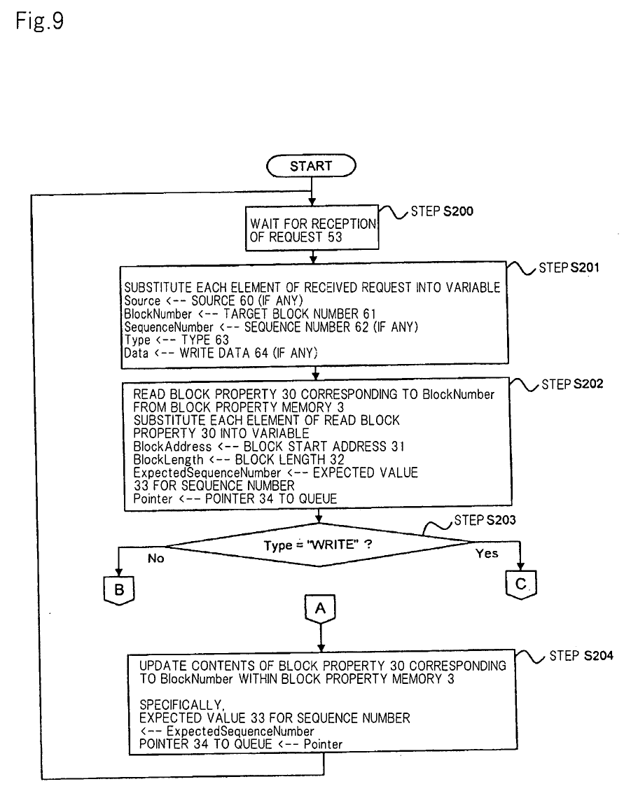

Next, an operation processing procedure of access arbitration unit 5 will be described with reference to FIGS. 9 through 13.

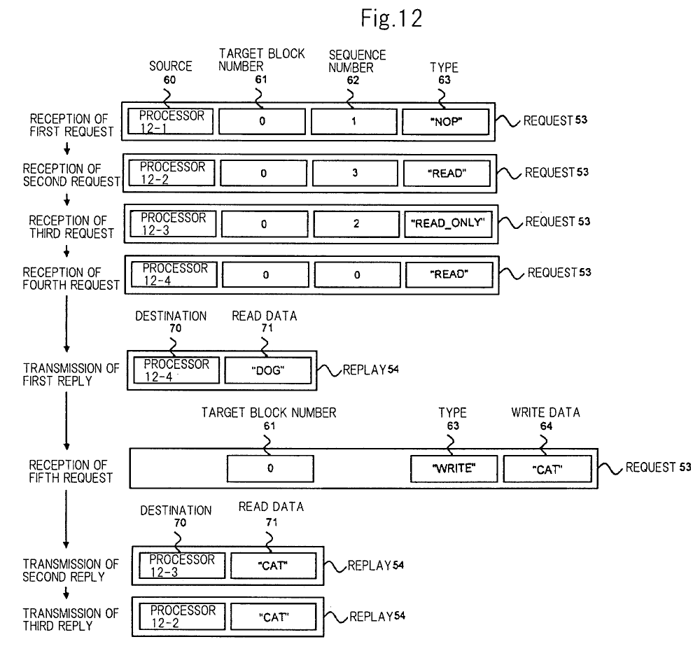

In this example, assume that five requests 53 shown in FIG. 12 are input in sequence from above into shared memory control unit 1. For simplicity, target block numbers 61 of these five requests 53 are all zero, so that block 20-1 alone is to be accessed in shared memory 2. It should be noted that FIG. 12 (10) also describes reply 54 returned by shared memory control unit 1.

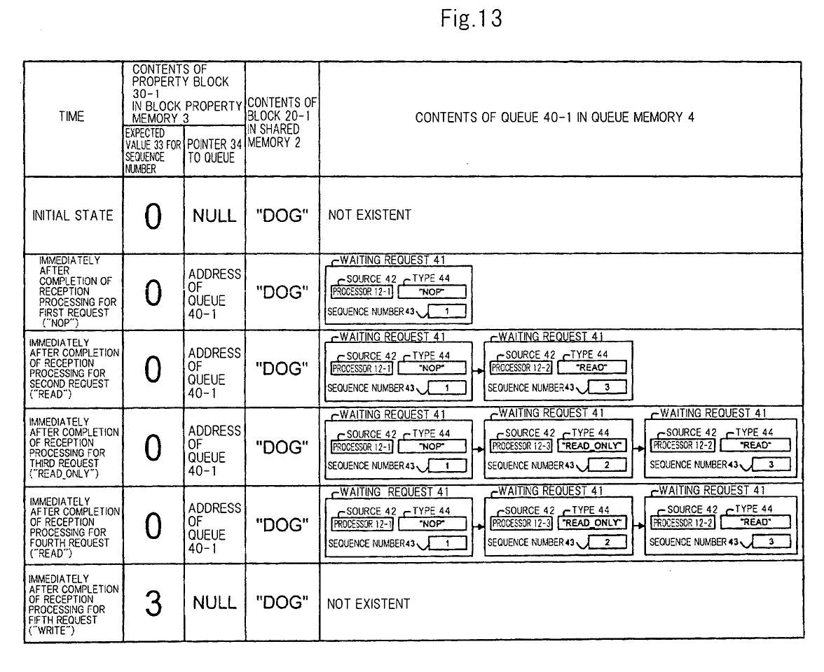

FIG. 13 shows the contents of block property 30-1, block 20-1, and queue 40-1 in an initial state and at the time that requests 53 have been processed. In this example, contents of block 20-1 are “DOG” in the initial state.

First, access arbitration unit 5 starts the processing of first NOP request 53 in FIG. 12 from step S200 of the flow chart in FIG. 9. At step S200, access arbitration unit 5 waits for the arrival of request 53. Here, NOP request 53 is received.

Upon receipt of request 53, access arbitration unit 5 goes to step S201, where each element of received request 53 is substituted into an associated variable. Specifically, access arbitration unit 5 substitutes source 60 of received request 53 into Source, target block number 61 into BlockNumber, sequence number 62 into SequenceNumber, type 63 into Type, and write data 64 into Data, respectively. It should be noted that depending on the type of request 53, source 60, sequence number 62, and write data 64 are absent, in which case absent elements are not substituted. In this example, Source=processor 12-1, BlockNumber=0, SequenceNumber=1, Type=NOP, and Data=indefinite at this time.

Access arbitration unit 5 next goes to step S202, where block property 30-(BlockNumber+1) is read from block property memory 3. Subsequently, access arbitration unit 5 substitutes each element of read block property 30 into the variable. Specifically, access arbitration unit 5 substitutes block start address 31 of block property 30 into Block Address, block length 32 into BlockLength, expected value 33 for the sequence number into ExpectedSequenceNumber, and pointer 34 to the queue into Pointer, respectively. In this example, BlockAddress=the start address of block 20-1 in shared memory 2, BlockLength=the length of block 20-1, ExpectedSequenceNumber=0 (initial value), and Pointer=NULL (initial value).

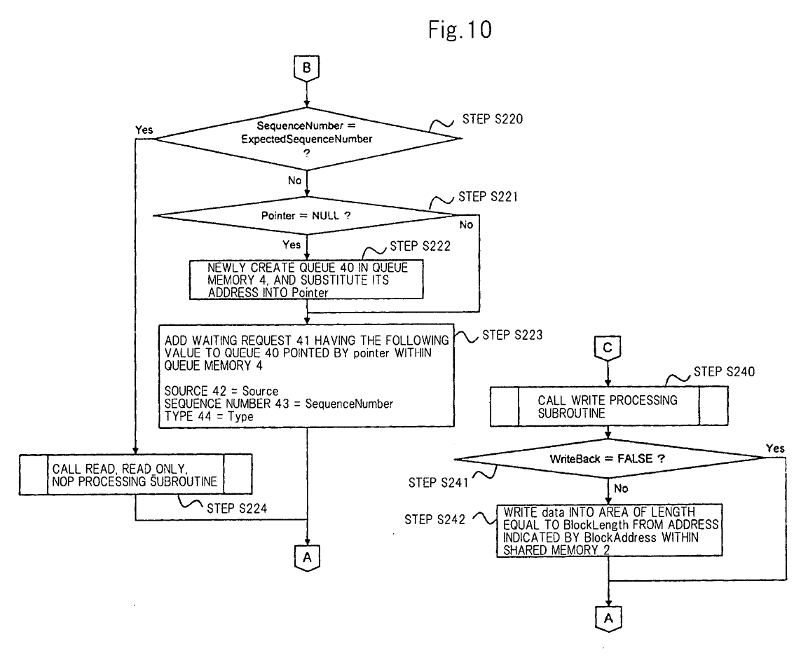

Access arbitration unit 5 next goes to step S203, where it determines whether or not Type is “WRITE. Access arbitration unit 5 transitions to step S240 in FIG. 10 when true, and transitions to step S220 in FIG. 10 when false. In this example, Type=NOP at this time, so that the determination result is false, causing access arbitration unit 5 to transition to step S220.

At step S220, access arbitration unit 5 determines whether or not SequenceNumber and ExpectedSequenceNumber have the same value, and goes to step S224 when true, and goes to step S211 when false. In this example, SequenceNumber=1, and ExpectedSequenceNumber=0 at this time, the determination result is false, causing access arbitration unit 5 to go to step S221.

At step S221, it is determined whether or not Pointer is NULL. When Pointer is NULL, i.e., when there exists no request 53 which is on hold to access block 20-(BlockNumber+1), access arbitration unit 5 goes to step S222. When Pointer is not NULL, access arbitration unit 5 goes to step S223. In this example, Pointer is NULL at this time, causing access arbitration unit 5 to go to step S222.

At step S222, access arbitration unit 5 creates new queue 40 in queue memory 4, and substitutes the address of created queue 40 into Pointer. In this example, the address of queue 40-1 in queue memory 4 is substituted into Pointer at this time.

Access arbitration unit 5 goes to step S223, where waiting request 41 is added to queue 40 indicated by Pointer, within queue memory 4. In this event, access arbitration unit 5 makes source 42 of added waiting request 41 equal to Source, sequence number 43 to SequenceNumber, and type 44 to Type. As described above, waiting requests 41 within queue 40 must be arranged such that their sequence numbers 43 are in an ascending order. Access arbitration unit 5 adds or inserts waiting request 41 into an appropriate position of queue 40 so as to satisfy this condition.

In this example, no waiting request 41 exist in queue 40-1 at this time. Accordingly, access arbitration unit 5 may simply add waiting request 41 having the following contents to the top of waiting queue 40-1 at this time. The contents of added waiting request 41 are as follows. Source 42=Processor 12-1, Sequence number 43=1, and Type 44=NOP. Subsequently, access arbitration unit 5 transitions to step S204 in FIG. 9.

At step S204, access arbitration unit 5 updates sequence number 33 and pointer 34 to the queue of block property 30-(BlockNumber+1) to the latest values. Specifically, access arbitration unit 5 updates sequence number 33 to ExpectedSequenceNumber, and pointer 34 to the queue to Pointer. In this example, since BlockNumber=0 at this time, block property 30-1 is to be updated. Also, since ExpectedSequenceNumber=0, and Pointer=address of queue 40-1, the value of sequence number 33 of block property 30-1 remains as “0,” and the value of pointer 34 to the queue changes from NULL to the “address of queue 40-1.”

According to the foregoing operations, reception processing is completed for first NOP request 53. Upon completion of the reception processing for first NOP request 53, access arbitration unit 5 returns to step S200 to wait for reception of new request 53. At this time, the contents of block property 30-1, block 20-1, and queue 40-1 are as shown on the second row from above in FIG. 13. Sequence number 62 of first NOP request 53 is “1.” This value does not match the value “0” of expected value 33 for the sequence number of block 20-1. For this reason, the execution of first NOP request 53 is suspended.

Access arbitration unit 5 next starts the processing of second READ request 53 in FIG. 12 from step S200 of the flow chart in FIG. 9. To avoid redundant descriptions, the following description will focus only on differences with the processing of first NOP request 53.

At step S200, access arbitration unit 5 goes to step S201 upon confirmation of the receipt of second READ request 53, and substitutes each element of received request 53 into an associated variable.

Execution of step S201 by access arbitration unit 5 results in Source=processor 12-2, SequenceNumber=3, and Type=READ. Execution of step S202 by access arbitration unit 5 results in ExpectedSequenceNumber=0, and Pointer=address of queue 40-1. Since the determination at S203 is false, access arbitration unit 5 goes to step S220 in FIG. 10. Since the determination at step S220 is also false, access arbitration unit 5 reaches step S221.

At step S221, since current Pointer is not NULL, the determination is false, unlike the preceding execution. Access arbitration unit 5 skips step S222 and goes to step S223. Specifically, since queue 40 has already been created, new queue 40 need not be created at step S222.

At step S223, access arbitration unit 5 adds waiting request 41 having the following contents to queue 40-1. The contents of added waiting request 41 are as follows. Source 42=processor 12-2, sequence number 43=3, type 44=READ.

However, queue 41 already contains waiting request 41 with sequence number 43=1 and type 44=NOP. For this reason, new waiting request 41 is added immediately after existing waiting request 41 such that sequence numbers 43 are in ascending order. Subsequently, access arbitration unit 5 transitions to step S204 in FIG. 9.

At step S204, sequence number 33 and pointer 34 to the queue of block property 30-1 are updated. In this example, ExpectedSequenceNumber=0, and Pointer=address of queue 40-1 at this time, and they are the same as the contents of block property memory 3. Thus, the contents of the memory do not change at this step.

According to the foregoing operations, reception processing is completed for second READ request 53. Upon completion of reception processing for second READ request 53, access arbitration unit 5 returns to step S200 to wait for the reception of new request 53. At this time, the contents of block property 30-1, block 20-1, and queue 40-1 are as shown on the third row from above in FIG. 13. Similar to the preceding time, the execution of second READ request 53 is suspended as well.

Next, access arbitration unit 5 starts the processing of third READ_ONLY request 53 in FIG. 12 from step S200 of the flow chart in FIG. 9. The flow of processing is basically the same as that for second READ request 53. Processing at step S223 in FIG. 10 is described because it is slightly different. At step S223, access arbitration unit 5 adds waiting request 41 that has the following contents to queue 40-1. The contents of added waiting requests 41 are as follows. Source 42=processor 12-3, sequence number 43=2, and type 44=“READ_ONLY.”

However, queue 40-1 already contains waiting request 41 with sequence number 43=1 and type 44=NOP and waiting request 41 with sequence number 43=3 and type 44=READ. For this reason, new waiting request 41 is inserted between two existing waiting requests 41.

Thus, reception processing is completed for third READ_ONLY request 53. Upon completion of reception processing for third READ_ONLY request 53, access arbitration unit 5 returns to step S200 to wait for the reception of new request 53. At this time, the contents of block property 30-1, block 20-1, and queue 40-1 are as shown on the fourth row from above in FIG. 13. Similar to the preceding time, the execution of third READ_ONLY request 53 is suspended as well.

Next, access arbitration unit 5 starts the processing for fourth READ request 53 in FIG. 12 from step S200 of the flow chart in FIG. 9. The processing up to immediately before step S220 in FIG. 10 is similar to the foregoing. In this example, settings or set states of the variables immediately before step S220 are as follows.

Source=processor 12-4;

BlockNumber=0;

SequenceNumber=0;

Type=READ;

Data=indefinite;

BlockAddress=start address of block 20-1 in shared memory 2;

BlockLength=length of block 20-1;

ExpectedSequenceNumber=0; and

Pointer=address of queue 40-1.

At step S220, it is determined whether or not SequenceNumber and ExpectedSequenceNumber have the same value. In this example, they are both zero at this time, so that the determination result is true. This causes access arbitration unit 5 to go to step S224. This means that execution of request 53 is permitted because sequence number 62 of request 53 matches expected value 33 for the sequence number of block property 30.

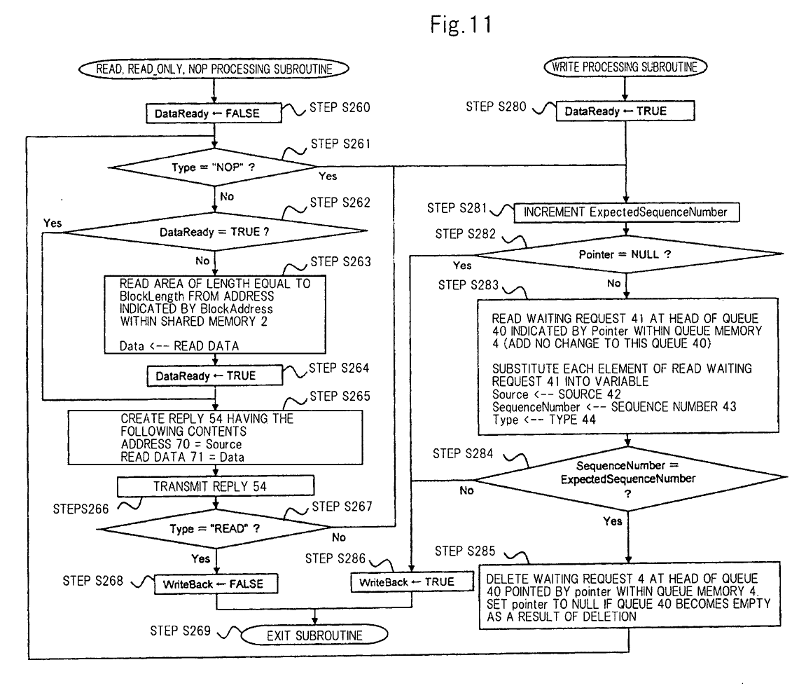

At step S224, a subroutine shown in FIG. 11 is called to process READ, READ_ONLY, and NOP. Since a majority of this subroutine is shared with a WRITE processing subroutine, later described, the subroutine is executed from two starting positions. When this subroutine is called from step S224, the subroutine starts at step S260.

At step S260, access arbitration unit 5 sets a DataReady flag to false. This flag is provided to prevent shared memory 2 from being read twice, and this flag changes to true at the time the contents of block 20-(BlockNumber+1) is reflected to Data. At the time step S260 is executed, Data is indefinite, so that this flag is set to false.

Next, access arbitration unit 5 goes to step S261, where it determines whether or not Type is NOP. Access arbitration unit 5 transitions to step S281 when the determination result is true, and transitions to step S262 when false. In this example, since Type=READ at this time, the determination result is false, causing access arbitration unit 5 to go to step S262.

At step S262, it is determined whether the DataReady flag is true or false. Access arbitration unit 5 jumps to step S265 when the flag is true, and goes to step S263 when false. In this example, since DataReady is false at this time, access arbitration unit 5 goes to step S263.

At step S263, access arbitration unit 5 reads the contents of block 20-(BlockNumber+1) in shared memory 2, and stores these contents in Data. The address from which reading the contents is started, and the length of the read contents are indicated by BlockAddress and BlockLength, respectively. In this example, the contents of block 20-1 are read at this time, resulting in Data=“DOG.” Next, access arbitration unit 5 goes to step S264, where DataReady flag is set to true.

Next, access arbitration unit 5 goes to step S265, where it creates reply 54 with Source contained in destination 70 and Data contained in read data 71, and transmits this reply 54 at step S266. In this example, since Source=processor 12-4, and Data=DOG at this time, access arbitration unit 5 returns reply 54 which includes “DOG” as read data 71 toward processor 12-4 which is source 60 of fourth READ request 53.

Access arbitration unit 5 goes to step S267, where it determines whether or not Type is “READ.” Access arbitration unit 5 transitions to step S268 when true, and transitions to step S281 when false. In this example, since Type=READ at this time, the determination result is true, causing access arbitration unit 5 to go to step S268.

At step S268, a WriteBack flag is set to false. Since this flag is significant only in the processing of WRITE request 53, a description thereon is omitted here. Access arbitration unit 5 goes to step S269 to exit this subroutine to return to the location from which the subroutine was called. In this example, this subroutine is called from step S224 in FIG. 10 at this time. The next step to step S224 is aforementioned step S204 in FIG. 9.

At step S204, sequence number 33 and pointer 34 to the queue of block property 30-1 are updated, where in this example, ExpectedSequenceNumber=0 and Pointer=address of queue 40-1 at this time, and they are the same as the contents of block property memory 3. Therefore, the contents of the memory are not changed at this step.

According to the foregoing, the processing is completed for fourth READ request 53. Upon completion of processing for fourth READ request 53, access arbitration unit 5 returns to step S200 to wait for reception of new request 53. At this time, the contents of block property 30-1, block 20-1, and queue 40-1 are as shown on the fifth row from above in FIG. 13. While fourth READ request 53 has been executed, three waiting requests 41 still remain within queue 40-1. This state continues until WRITE request 53 arrives at and is processed by access arbitration unit 5.

Finally, access arbitration unit 5 starts the processing for fifth WRITE request 53 in FIG. 12 from step S200 of the flow chart in FIG. 9. The processing up to immediately before step S203 is similar to the foregoing. In this example, settings or set states of the variables immediately before step S203 are as follows.

Source=indefinite;

BlockNumber=0;

SequenceNumber=indefinite;

Type=“WRITE”;

Data=“CAT”;

BlockAddress=start address of block 20-1 in shared memory 2;

BlockLength=length of block 20-1;

ExpectedSequenceNumber=0; and

Pointer=address of queue 40-1.

At step S230, it is determined whether or not Type is “WRITE.” In this example, since Type=WRITE at this time, the determination result is true. Accordingly, access arbitration unit 5 transitions to step S240 in FIG. 10.

At step S240, the WRITE processing subroutine shown in FIG. 11 is called. When this subroutine is called from step S240, the subroutine is started from step S280.

At step S280, access arbitration unit 5 sets a DataReady flag to true, and prohibits reading from block 20-(BlockNumber+1) in shared memory 2 to prevent the contents of Data from being disrupted until the processing for WRITE request 53 is completed. The reason for prohibiting reading the contents lies in that write data 64 of WRITE request 53, i.e., Data is more recent than current contents of block 20-(BlockNumber+1).

Access arbitration unit 5 goes to step S281, where “1” is added to ExpectedSequenceNumber. In this example, ExpectedSequenceNumber changes from “0” to “1” at this time.

Next, access arbitration unit 5 goes to step S282, where it determines whether or not Pointer is NULL. Access arbitration unit 5 transitions to step S286 when Pointer is NULL, and transitions to step S283 when not NULL. In this example, Pointer is the address of queue 40-1 and is not NULL at this time. Accordingly, access arbitration unit 5 goes to step S283.

At step 283, access arbitration unit 5 reads first waiting request 41 in queue 40 pointed by Pointer, and substitutes each of its elements into the associated variable. Specifically, access arbitration unit 5 substitutes source 42 of waiting request 41 into Source, sequence number 43 into SequenceNumber, and type 44 into Type, respectively. It should be noted that at this step, access arbitration unit 5 simply reads the contents of waiting request 41, and does not modify queue 40. In this example, waiting request 41 at the head of queue 40-1 pointed by Pointer is read at this time, resulting in Source=Processor 12-1, SequenceNumber=1, and Type=NOP.

At step S284, it is determined whether or not SequenceNumber and ExpectedSequenceNumber have the same value. Access arbitration unit 5 transitions to step S285 when they have the same value, and transitions to step S286 when not. In this example, they are both “1” at this time, so that the determination result is true. Accordingly, access arbitration unit 5 transitions to step S285. This means that sequence number 43 of waiting request 41 matches expected value 33 for the sequence number of block property 30, so that the execution of this waiting request 41 is permitted.

Next, access arbitration unit 5 goes to step S285, where it deletes waiting request 41 at the head of queue 40 pointed by Pointer. Further, if that queue 40 becomes empty as a result of the deletion, access arbitration unit 5 substitutes NULL into Pointer. In this example, two waiting requests 42 remain in queue 40-1 at this time even after the deletion, so that Pointer remains pointing to queue 40-1. Subsequently, access arbitration unit 5 returns to step S261.

In this way, this subroutine includes a loop, such that the processing within the subroutine is repeated until step S268 or step S286 is reached. Basically, waiting requests 41 within queue 40 are sequentially executed from the head as long as waiting requests 41 exist within queue 40 pointed by Pointer, and as long as sequence number 43 of waiting request 41 at the head of that queue 40 continues to match ExpectedSequenceNumber. However, as the execution of READ request 53 is completed, access arbitration unit 5 exits the loop without fail irrespective of the presence or absence of waiting request 41 at that time (step S267).

Next, a description will be given of reasons for which READ is treated as an exception.

As described in the description of the operations associated with READ request 53, when READ request 53 is executed and reply 54 is returned to source 60, this source 60 must issue WRITE request 53 without fail. This WRITE request 53 can rewrite the contents of shared memory 2. Therefore, execution of waiting request 41, prior to the completion of the processing for WRITE request 53 corresponding to READ request 53, should not be permitted because the validity of the processing can be lost. For this reason, in this embodiment, the loop is terminated at the time the execution of READ request 53 has been completed so as not to execute subsequent waiting request 41.

Turning back to the description on step S261, it is determined whether or not Type is NOP at step S261. In this example, since Type=NOP at this time, this determination result is true. Accordingly, access arbitration unit 5 goes to step S281. Since the processing up to immediately before step S283 is similar to that in the preceding execution, a description thereon is omitted. ExpectedSequenceNumber is increased to “2.”

At step S283, waiting request 41 at the head of queue 40-1 pointed by Pointer is read, resulting in Source=processor 12-3, SequenceNumber=2, and Type=READ_ONLY.

At step S284, it is determined whether or not SequenceNumber and ExpectedSequenceNumber have the same value. In this example, both are “2” at this time, so that the determination result is true. Accordingly, access arbitration unit 5 goes to step S285.

At step S285, waiting request 41 is deleted at the head of queue 40 pointed by Pointer, but even after the deletion, one waiting request 42 still remains in queue 40-1. As such, Pointer remains pointing to queue 40-1. Subsequently, access arbitration unit 5 returns to step S261.

At step S261, it is determined whether or not Type is NOP. In this example, since Type=READ_ONLY at this time, the determination result is false. Accordingly, access arbitration unit 5 goes to step S262.

At step S262, it is determined whether the DataReady flag is true or false. In this example, since DataReady is true at this time, access arbitration unit 5 skips step S263 and step S264 and jumps to step S265.

At step S265 and step S266, reply 54 is generated and transmitted. In this example, Source=processor 12-3, and Data=“CAT” at this time. Accordingly, reply 54 including “CAT” as read data 71 is returned to processor 12-3 which is source 60 of third READ_ONLY request 53.

Access arbitration unit 5 goes to step S267, where it is determined whether or not Type is “READ.” In this example, since Type=READ_ONLY at this time, the determination result is false. Accordingly, access arbitration unit 5 goes to step S281. Since the processing up to immediately before step S283 is similar to that in the preceding execution, a description thereon is omitted. ExpectedSequenceNumber is increased to “3.”

At step S283, waiting request 41 is read from the head of queue 40-1 pointed by Pointer, resulting in Source=processor 12-2, SequenceNumber=3, and Type=READ.

At step S284, it is determined whether or not SequenceNumber and ExpectedSequenceNumber have the same value. In this example, both are “3” at this time, so that the determination result is true. Accordingly, access arbitration unit 5 goes to step S285. At step S285, waiting request 41 is deleted from the head of queue 40 pointed by Pointer. As a result, any waiting request 41 does not exist in queue 40-1. Thus, Pointer is set to NULL. Subsequently, access arbitration unit 5 returns to step S261.

At step S261, it is determined whether or not Type is NOP. In this example, since Type=READ at this time, the determination result is false. Accordingly, access arbitration unit 5 goes to step S262. At step S262, it is determined whether the DataReady flag is true of false. In this example, since DataReady is true at this time, access arbitration unit 5 skips step S263 and step S264 and jumps to step S265.

At step S265 and step S266, reply 54 is generated and transmitted. In this example, source=processor 12-2, and Data=“CAT” at this time. Thus, reply 54 including “CAT” as read data 71 is returned to processor 12-2 which is source 60 of second READ request 53.

Access arbitration unit 5 goes to step S267, where it is determined whether or not Type is “READ.” In this example, since Type=READ at this time, the determination result is true. Accordingly, access arbitration unit 5 exits the loop and goes to step S268. At step S268, a WriteBack flag is set to false. This flag is set to true when contents of Data must be written into block 20-(BlockNumber+1) in shared memory 2.

Next, access arbitration unit 5 goes to step S269, and exits this subroutine to return to the location from which the subroutine was called. In this example, since the subroutine is called from step S240 in FIG. 10 at this time, the next step is step S241.

At step S241, it is determined whether the WriteBack flag is true or false. Access arbitration unit 5 goes to step S242 when the flag is true, and skips step S242 when false. In this example, since WriteBack is false at this time, access arbitration unit 5 skips step S242, and transitions to step S204 in FIG. 9.

At step S204, sequence number 33 and pointer 34 to the queue of block property 30-1 are updated. In this example, ExpectedSequenceNumber=3, and Pointer=NULL at this time. Thus, sequence number 33 and pointer 34 to queue of block property 30-1 are updated to “3” and NULL, respectively.

With the foregoing, the processing is completed for fifth WRITE request 53, and access arbitration unit 5 returns to step S200 to wait for reception of new request 53. At this time, the contents of block property 30-1, block 20-1, and queue 40-1 are as shown on the sixth row from above in FIG. 13.

In this example, step S242 in FIG. 10 and step S286 in FIG. 11 are not executed, so that contents of processing at these steps will be next described.

At step S242, access arbitration unit 5 writes contents of Data into block 20-(BlockNumber+1) in shared memory 2. The address at which writing the contents is started, and the length of written data are indicated by BlockAddress and BlockLength, respectively. Subsequently, access arbitration unit 5 goes to step S204 in FIG. 9. On the other hand, at step S286, access arbitration unit 5 sets the WriteBack flag to true, and then transitions to step S269.

Here, a description will be given of the nature of access arbitration unit 5.

In this example, the processing was performed for WRITE request 53 which has write data 64 “CAT.” However, as is apparent from FIG. 13, the contents of block 20-1 in shared memory 2 still remain as “DOG.” At a glance, it appears that information “CAT” is lost, and the contents of block 20-1 suffer from mismatching, but actually, this is not true. Information “CAT” is preserved as read data 71 in third replay 54 transmitted by shared memory control unit 1 last, as shown in FIG. 12. Third replay 54 corresponds to second READ request 53.

Source 60 of second READ request 53 is responsible for issuing WRITE request 53 (not shown in FIG. 12) after receipt of third reply 54. In other words, at the time that reply 54 is corresponding to READ request 53 is returned, the reception of WRITE request 53 is established. If it is known that contents of shared memory 2 will be rewritten by this WRITE request 53 at a later time, it will be apparent that the same area of shared memory 2 need not be rewritten before that. Rather, redundant accesses to shared memory 2 should be restrained in order to reduce a load on shared memory 2 and improve the performance of the same.

To this end, access arbitration unit 5 skips the update processing (at step S242) for shared memory 2 caused by WRITE request 53 when type 44 of last executed waiting request 41 is “READ” among waiting requests 41 which have been executed in response to the arrival of WRITE request 53.

Also, in this example, while a total of four requests 53 were issued with the possibility to generate accesses to shared memory 2 (two READs, one READ_ONLY, and one WRITE), one access was actually generated. Shared memory 2 was accessed only once because access arbitration unit 5 successively executed three waiting requests 41 in response to the arrival of WRITE request 53, and because access arbitration unit 5 referenced write data 64 within received WRITE request 53 instead of reading data from shared memory 2 during the execution of these requests 41.

More generally speaking, when access arbitration unit 5 successively executes one or more waiting requests 41 in response to the arrival of any request 53, not limited to WRITE, shared memory 2 is accessed only once at most in total. This will be described with reference to the flow charts (FIGS. 9 through 11) of the operations of access arbitration unit 5. A read access from shared memory 2 is executed at step S263 in FIG. 11, while a write access is executed at step S242 in FIG. 10, respectively.

First, a read from shared memory 2 is explained. As described above, the subroutine of FIG. 11 includes a loop, where as long as the condition is satisfied for executing waiting request 41 at the head of queue 40, access arbitration unit 5 returns from step S285 to step S261, i.e., the start of the loop to continue the processing. Here, for executing step S263 at which shared memory 2 is read, the DataReady flag must be false (step S262). As step S263 is executed, the DataReady flag is set to true without fail (step S264). Therefore, step S263 is executed only once no matter how many times the loop is executed. Also, when the subroutine of FIG. 11 is called during the processing of WRITE request 53, step S280 is executed at the beginning, and the DataReady flag is set to true. Thus, step S263 cannot be executed during the processing of WRITE request 53. Accordingly, shared memory 2 is not read even once during the processing of WRITE request 53, and except for a write request shared memory 2 is read only once at most during the processing of request 53.

Next, a write into shared memory 2 is explained. To execute step S242 at which shared memory 2 is written, type 63 of request 53 received by access arbitration unit 5 must be “WRITE” (step S203 in FIG. 9). Specifically, step S242 is part of processing inherent to WRITE request 53. Further, the execution of step S242 can be skipped depending on the determination result at step S241. Therefore, shared memory 2 is written only once at most during the processing of WRITE request 53, and except for a write request shared memory 2 is not written even once during the processing of request 53.

Accordingly, when access arbitration unit 5 successively executes one or more waiting requests 41 in response to the arrival of any one of requests 53, shared memory 2 is accessed only once at most in total.

As described above, since a plurality of waiting requests 41 can be collectively processed more frequently, shared memory control unit 1 can reduce a load on shared memory 2 and improve the processing performance for requests 53. Such a situation is more likely to appear when processors 12-1-12-P frequently issue requests 53 to shared memory control unit 1 in processing system 6, and a plurality of waiting requests 41 stay in queue 40 of queue memory 4. In other words, it can be said that the processing efficiency of shared memory control unit 1 is relatively improved when the entire processing system 6 is heavily loaded.

To facilitate the description, in the specific example given in the description of the operation of access arbitration unit 5, only block 20-1 in shared memory 2 is to be accessed. Actually, however, processors 12 (12-1, 12-2, . . . , 12-P) can simultaneously access a plurality of blocks 20. In this event, exclusive control is not at all conducted among two or more requests 53 which differ in access intended block 20, i.e., target block number 61 from one another.

While the embodiment of the present invention has been described in detail with reference to the drawings, the specific configuration is not limited to this embodiment, modifications and the like in design, without departing from the spirit of the invention, are included in the present invention. For example, while the foregoing embodiment has been described in connection with a packet input communication system to which the present invention is applied, the present invention is not so limited, but can be applied to parallel processing systems for other applications as long as they involves processing which has the order dependency.

For example, in the foregoing embodiment, a communication is assumed as an application of shared memory control unit 1, but the present invention is not essentially limited to the communication. Any processing having the order dependency can be implemented using processing system 6 when packet 50, which is input of processing system 6, is replaced with “processing target,” and when a flow in a communication is replaced with a “set of processing targets associated with one another,” respectively.

Also, while shared memory control unit 1 according to the foregoing embodiment provides a shared memory access exclusive control function that recognizes the sequence, shared memory control unit 1 can also conduct exclusive control that recognizes the sequence for shared resources except for memories without modifications. A description will be given of how to utilize shared memory control unit 1 in such control.

First, block 20 in shared memory 2 corresponds to a shared resource. When a plurality of shared resources are to be exclusively controlled, different blocks 20 are assigned to the respective shared resources without overlapping. Next, processor 12 which wishes to gain a shared resource use right issues READ request 53 to shared memory control unit 1 for block 20 corresponding to the shared resource. This processor 12 determines to acquire the shared resource when it receives reply 54 from shared memory control unit 1 After utilizing the shared resource, processor 12 itself issues WRITE request 53 intended for block 20 corresponding to the shared resource to release the shared resource.

### INDUSTRIAL AVAILABILITY

The embodiment described above can be widely applied to data processing systems which parallelly execute data processing having an order dependency in an environment in which a plurality of processors exist.

According to the embodiment described above, the same number of function as the number of areas defined within a shared memory can be independently provided in which the functions have a shared resource exclusive control that recognizes the order, which is required to parallelly execute processing having the order dependency, such as communication processing in an environment in which a plurality of processors exist. Accordingly, it is possible to reduce the amount of data communication between processors, achieve low power consumption, and conduct a shared resource exclusive control that recognizes the order.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A shared memory control method for parallelly processing ordered access requests for a shared memory, received from a plurality of processors or threads, said method comprising:
dividing said shared memory into a plurality of memory areas;
receiving the ordered access request from said processor or thread for each of said memory areas;
executing the access request when a described order number described in the access request matches an expected order number expected by said memory area to be accessed;
increasing or decreasing the expected order number expected by said memory area to be accessed by a predetermined number when the type of the access request is “READ ONLY” or “WRITE” or “NO OPERATION”;
saving the access request into a queue independently assigned to each of said memory areas when the described order number described in the access request does not match the expected order number expected by said memory area to be accessed; and
sequentially fetching the access request from the queue and executing the access request as long as a described order number described in the access request preserved in the queue matches an expected order number expected by said memory area corresponding to the queue.

2. A shared memory control method for parallelly processing ordered access requests for a shared memory, received from a plurality of processors or threads, said method comprising:
dividing said shared memory accessible from said plurality of processors or threads into a plurality of memory areas;
receiving the ordered access request from said processor or thread for each of said memory areas;
executing the access request when a described order number described in the access request matches an expected order number expected by said memory area to be accessed;
not changing the expected order number expected by said memory area to be accessed when the type of the access request is a “READ associated with a future WRITE”;
increasing or decreasing the expected order number expected by said memory area to be accessed by a predetermined number when the type of the access request is “READ ONLY” or “WRITE” or “NO OPERATION”;
saving the access request into a queue independently assigned to each of said memory areas when the described order number described in the access request does not match the expected order number expected by said memory area to be accessed; and
sequentially fetching the access request from the queue and executing the access request as long as a described order number described in the access request preserved in the queue matches an expected order number expected by said memory area corresponding to the queue.

3. The shared memory control method according to claim 2, further comprising:
saving the access request into a queue independently assigned to each of said memory areas when the described order number described in the access request except for the access request, the type of which is “WRITE” does not match the expected order number expected by said memory area to be accessed; and
sequentially fetching the access request from the queue and executing the access request as long as a described order number described in the access request preserved in the queue matches an expected order number expected by said memory area corresponding to the queue.

4. The shared memory control method according to claim 2, wherein:
when one or more access requests preserved in a queue corresponding to said memory area are sequentially executed in response to an update of the expected order number expected by said memory area to be accessed, resulting from the execution of an access request, the type of which is “WRITE,” received from said processor or thread, write data included in the access request, the type of which is “WRITE,” is referenced for processing instead of reading data from said memory area;
when the type of the last executed access request is “READ ONLY” or “WRITE” or “NO OPERATION,” write data included in the access request, the type of which is “WRITE,” is written into said memory area; and
when the type of the last executed access request is “READ associated with future WRITE,” write data included in the access request, the type of which is “WRITE,” is not written into said memory area.

5. The shared memory control method according to claim 2, wherein:
when one or more access requests preserved in a queue corresponding to said memory area are sequentially executed in response to an update of the expected order number expected by said memory area to be accessed, resulting from the execution of an access request, the type of which is “READ ONLY” or “NO OPERATION,” received from said processor or thread, a flag is provided to indicate whether or not data has been read from said memory area; and
if the referenced flag indicates that the data has been read even once in the past, when said memory area is next referenced, the access request is processed with reference to the data read in the past without performing a new read operation.

6. A shared memory control circuit for parallelly processing ordered access requests for a plurality of memory areas which partition shared memory, said access requests received from a plurality of processors or threads, said circuit comprising:
a memory area information memory that stores an expected order number expected by said memory area, and that stores a queue identifier for said memory area for each of said memory areas;
a set of queues capable of preserving the access request received from said processor or thread in each memory area to be accessed; and
an access arbitration unit configured to:
read the expected order number expected by said memory area to be accessed, and read the queue identifier of said memory area to be accessed from said memory area information memory each time an access request is received from said processor or thread, and execute the access request when a described order number described in the access request matches the order number expected by said memory area to be accessed;
increase or decrease the expected order number expected by said memory area to be accessed by a predetermined number when the type of the access request is “READ ONLY” or “WRITE” or “NO OPERATION”;
save the access request into a queue independently assigned to each of said memory areas when the described order number described in the access request does not match the expected order number expected by said memory area to be accessed; and
sequentially fetch the access request from the queue and execute the access request as long as a described order number described in the access request preserved in the queue matches an expected order number expected by said memory area corresponding to the queue.

7. A shared memory control circuit for parallelly processing ordered access requests for a plurality of memory areas which partition shared memory, said access requests received from a plurality of processors or threads, said circuit comprising:
a memory area information memory that stores an expected order number expected by said memory area, that stores and a queue identifier for said memory area for each of said memory areas;
a set of queues capable of preserving the access request received from said processor or thread in each memory area to be accessed; and
an access arbitration unit configured to:
read the expected order number expected by said memory area to be accessed, and read the queue identifier of said memory area to be accessed from said memory area information memory each time an access request is received from said processor or thread, and execute the access request when a described order number described in the access request matches an expected order number expected by said memory area to be accessed;
not change the expected order number expected by said memory area to be accessed when the type of the access request is a “READ associated with a future WRITE”;
increase or decrease the expected order number expected by said memory area to be accessed by a predetermined number when the type of the access request is “READ ONLY” or “WRITE” or “NO OPERATION”;
save the access request into a queue independently assigned to each of said memory areas when the described order number described in the access request does not match the expected order number expected by said memory area to be accessed; and
sequentially fetch the access request from the queue and execute the access request as long as a described order number described in the access request preserved in the queue matches an expected order number expected by said memory area corresponding to the queue.

8. The shared memory control circuit according to claim 7, wherein said access arbitration unit is configured to:
save the access request into a queue independently assigned to each of said memory areas when the described order number described in the access request except for the access request, the type of which is “WRITE” does not match the expected order number expected by said memory area to be accessed; and
sequentially fetch the access request from the queue and execute the access request as long as a described order number described in the access request preserved in the queue matches an expected order number expected by said memory area corresponding to the queue.

9. The shared memory control circuit according to claim 7, wherein:
when one or more access requests preserved in a queue corresponding to said memory area are sequentially executed in response to an update of the expected order number expected by said memory area to be accessed, resulting from the execution of an access request, the type of which is “WRITE,” received from said processor or thread, said access arbitration unit is configured to reference write data included in the access request, the type of which is “WRITE,” for processing, instead of reading data from said memory area,
when the type of the last executed access request is “READ ONLY” or “WRITE” or “NO OPERATION,” said access arbitration unit is configured to write the write data included in the access request, the type of which is “WRITE,” into said memory area; and
when the type of the last executed access request is “READ associated with future WRITE,” said access arbitration unit is configured not to write the write data included in the access request, the type of which is “WRITE,” into said memory area.

10. The shared memory control circuit according to claim 7, wherein:
when one or more access requests preserved in a queue corresponding to said memory area are sequentially executed in response to an update of the expected order number expected by said memory area to be accessed, resulting from the execution of an access request, the type of which is “READ ONLY” or “NO OPERATION,” received from said processor or thread, said access arbitration unit is configured to provide a flag to indicate whether or not data has been read from said memory area; and
if the referenced flag indicates that the data has been read even once in the past, when said memory area is next referenced, said access arbitration unit is configured to process the access request with reference to the data read in the past without performing a new read operation.

11. A computer readable recording medium which has recorded thereon a program for causing a computer to execute shared memory control processing for parallelly processing ordered access requests for a shared memory, received from a plurality of processors or threads, said shared memory control processing comprising:
dividing said shared memory into a plurality of memory areas;
receiving the ordered access request from said processor or thread for each of said memory areas;
executing the access request when a described order number described in the access request matches an expected order number expected by said memory area to be accessed;
increasing or decreasing the expected order number expected by said memory area to be accessed by a predetermined number when the type of the access request is “READ ONLY” or “WRITE” or “NO OPERATION”;
saving the access request into a queue independently assigned to each of said memory areas when the described order number described in the access request does not match the expected order number expected by said memory area to be accessed; and
sequentially fetching the access request from the queue and executing the access request as long as a described order number described in the access request preserved in the queue matches an expected order number expected by said memory area corresponding to the queue.

12. A shared memory control circuit for parallelly processing ordered access requests for a plurality of memory areas which partition shared memory, said access requests received from a plurality of processors or threads, said circuit comprising:
a memory area information memory that stores an expected order number expected by said memory area, and a queue identifier for said memory area for each of said memory areas;
queues means for being capable of preserving the access request received from said processor or thread in each memory area to be accessed; and
access arbitration means for configured to:
read the expected order number expected by said memory area to be accessed, and read the queue identifier of said memory area to be accessed from said memory area information memory each time an access request is received from said processor or thread, and execute the access request when a described order number described in the access request matches the order number expected by said memory area to be accessed;
increase or decrease the expected order number expected by said memory area to be accessed by a predetermined number when the type of the access request is “READ ONLY” or “WRITE” or “NO OPERATION”;
save the access request into a queue independently assigned to each of said memory areas when the described order number described in the access request does not match the expected order number expected by said memory area to be accessed; and
sequentially fetch the access request from the queue and execute the access request as long as a described order number described in the access request preserved in the queue matches an expected order number expected by said memory area corresponding to the queue.
